(19) United States
(12) Patent Application Publication
(10) Pub. No.: US 2005/0092186 A1
(43) Pub. Date: May 5, 2005

(54) Method for forming round strip food and apparatus realizing the method

(76) Inventor: Ou-Young Robert, Taipei Hsien (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/697,192

(22) Filed: Oct. 29, 2003

(51) Int. Cl. A23L 1/00

(52) U.S. Cl. 99/353

(57) ABSTRACT

A method for forming round strip food comprises at least moving horizontally a soft and deformable outer material to a predetermined distance and stopping the movement of the outer material; placing a stuffing upon an upper surface of the outer material; lifting and turning two lateral piece-bodies of the outer material at two sides of the moving path of the outer material to cover upon an upper surface of the stuffing; lifting and turning the outer material along the moving path to cover upon the lateral piece-bodies; and rolling the stuffing with the outer material enclosing thereon so that the outer material wound around the stuffing so as to form a round strip food. A round strip food shaping apparatus is enclosed. The apparatus can perform above mentioned method.

### FIELD OF THE INVENTION

The present invention relates to round strip foods, and particularly to a method for forming round strip food and an apparatus realizing the method.

### BACKGROUND OF THE INVENTION

Conventionally, a dough strip is placed on a transfer device and then is transferred horizontally. An oblique roller is framed above the transfer belt surface. When the moving dough touches the roller, the end of the dough is cured so as to form a dough strip. However this can not be used for dough with outer enclosing material, such as leaves of vegetables, fruits, etc. Thereby, there is an eager demand for a novel design which can improve the prior art defects.

### SUMMARY OF THE INVENTION

Accordingly, the primary object of the present invention is to provide a round strip food shaping apparatus which cause thin outer materials to receive fillings therein. The two lateral pieces and front ends of the outer material are folded to enclose stuffing by using a right upper piece. Then the outer material and stuffing are rolled to form as a round strip food. The round strip foods can be supplied continuously. Furthermore, non-extendable outer material is usable in the apparatus of the present invention.

Another object of the present invention is to provide a method for forming round strip food which comprises the step of moving horizontally a soft and deformable outer material to a predetermined distance and stopping the movement of the outer material; placing a stuffing upon an upper surface of the outer material; lifting and turning two lateral piece-bodies of the outer material at two sides of the moving path of the outer material to cover upon an upper surface of the stuffing; lifting and turning the outer material along the moving path to cover upon the lateral piece-bodies; and rolling the stuffing with the outer material enclosing thereon so that the outer material wound around the stuffing so as to form a round strip food. A round strip food shaping apparatus is enclosed. The apparatus can perform above mentioned method.

The various objects and advantages of the present invention will be more readily understood from the following detailed description when read in conjunction with the appended drawing.

### BRIEF DESCRIPTION OF THE DRAWINGS

FIG. 1 is an upper view of the present invention.

FIG. 2 is a lateral view of the present invention.

FIG. 3 is a partial perspective view showing the transfer device and outer material according to the present invention.

FIG. 4 is a cross section view showing that a stuffing is provided to the outer material according to the present invention.

FIG. 5 is a perspective view showing the lateral sliding block of the present invention.

FIG. 6 is a perspective view of the upper sliding block of the present invention.

FIG. 7 is an operational cross section view showing the process that the lateral piece-bodies of the outer material is being turned upwards.

FIG. 8 is an operational cross section view showing that the lateral piece-bodies of the outer material have turned upwards.

FIG. 9 is an operational cross section view showing the blades return to the horizontal position from a longitudinal position.

FIG. 10 is an upper view showing the blades of the present invention is turned and restores to the horizontal position.

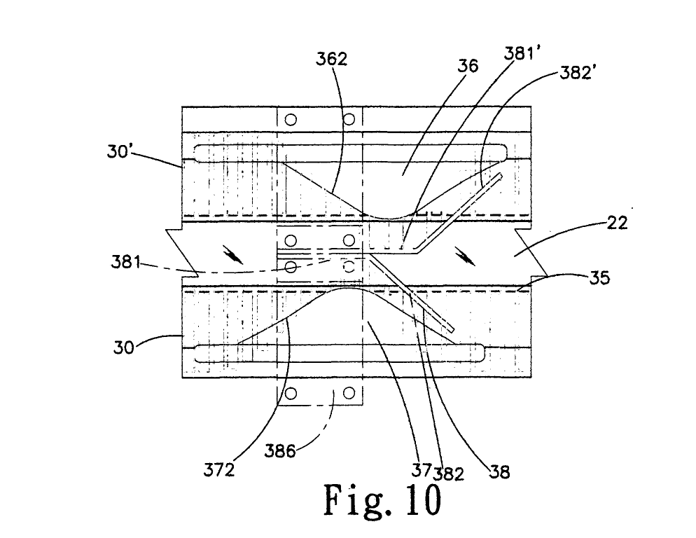

FIG. 11 is a perspective view showing that the blades are turned upwards and returned to a horizontal position.

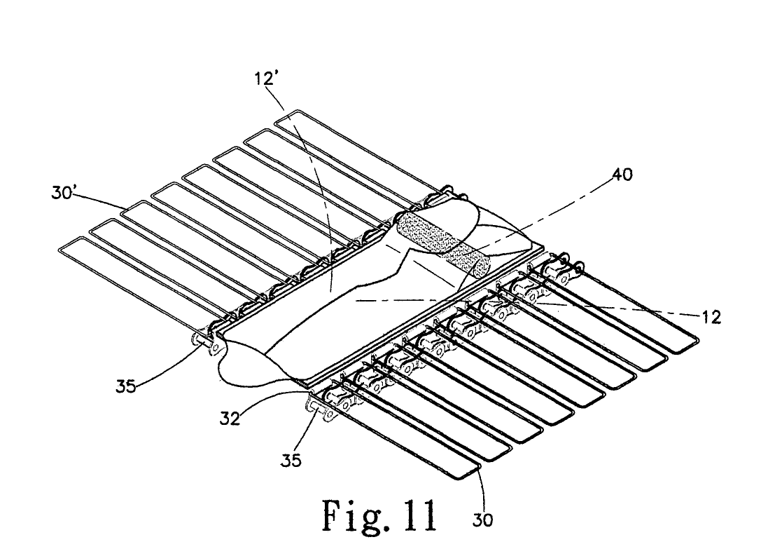

FIG. 12 is an exploded perspective view the folding apparatus and net movably to the retaining frames.

FIG. 13 is a first operational cross section view of the folding apparatus of the present invention.

FIG. 14 is a second first operational cross section view of the folding apparatus of the present invention.

FIG. 15 is a third first operational cross section view of the folding apparatus of the present invention.

FIG. 16 is a fourth first operational cross section view of the folding apparatus of the present invention.

FIG. 17 is an operation cross section view showing that the outer material is wound as a round strip food.

### DETAILED DESCRIPTION OF THE PREFERRED EMBODIMENTS

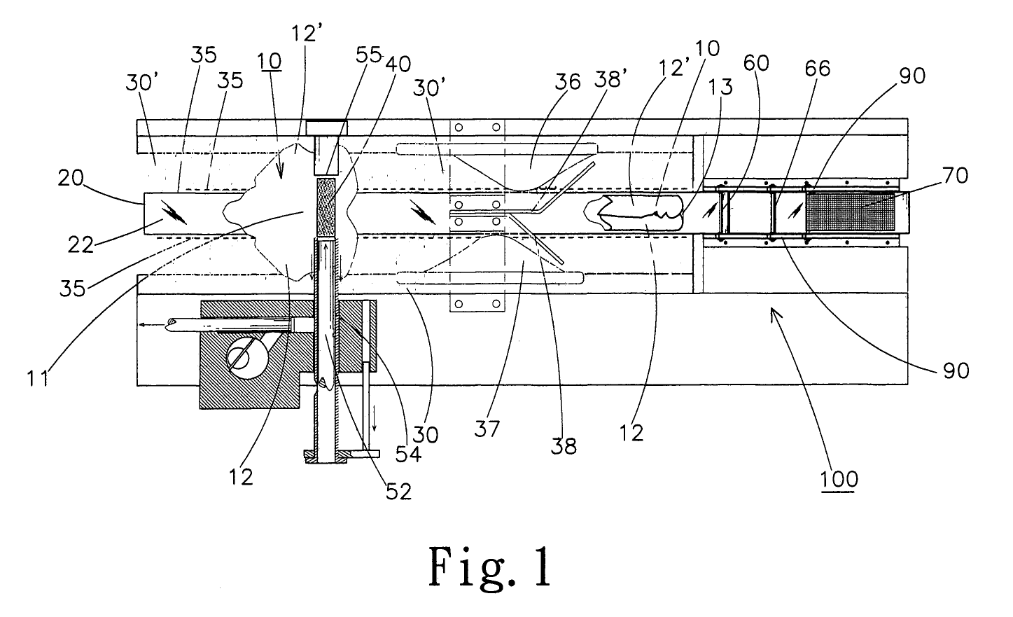

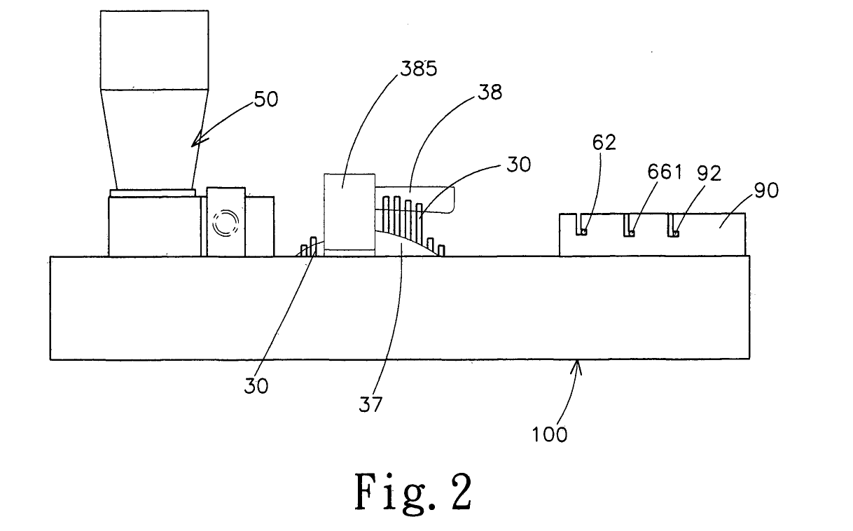

Referring to FIGS. 1 and 2, the round strip food shaping apparatus 100 of the present invention is illustrated. The round strip food shaping apparatus 100 comprises the following elements.

A transfer device 20 has a transfer belt surface 22 which moves forwards along a specific direction.

A plurality of right blades 30 and a plurality of left blades 30′ are installed at two lateral sides of the transfer belt surface 22. The distal end of each right blade 30 and each left blade 30′ has a respective axial portion 32. The right blades 30 and left blades 30′ move forward along a specific direction. The movement of the left blades 30′ and right blades 30 are identical and synchronous to the transfer belt surface 22. In the moving process, the right blades 30 and left blades 30′ rotate upwards along respective axial portions 32 sequentially from a horizontal direction to a predetermined angle and then rotate downwards sequentially to the horizontal direction.

At least one piece of outer material 10 is used for enclosing a stuffing 40. If a plurality of outer materials 10 are used, they are equi-distance and horizontally arranged on the transfer belt surface 22. The at least one outer material 10 has two lateral piece-bodies 12, 12′ which are attached to the surface of the right blades 30 and left blades 30′.

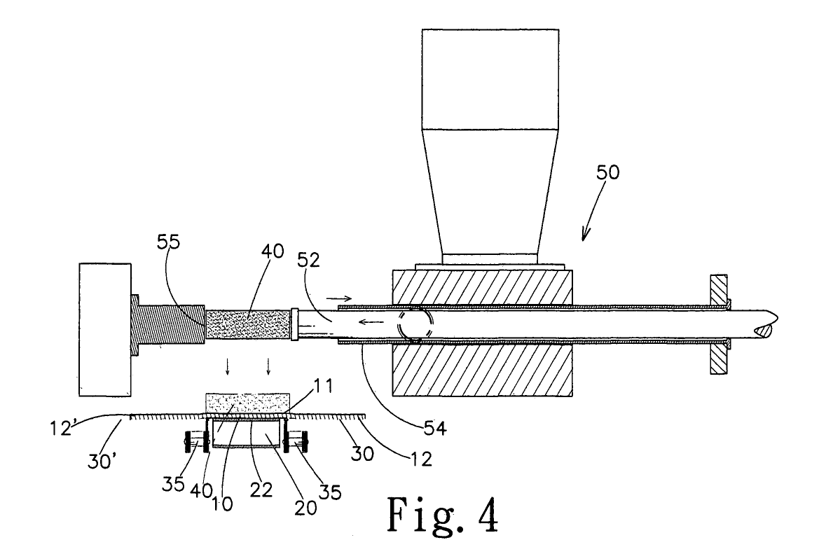

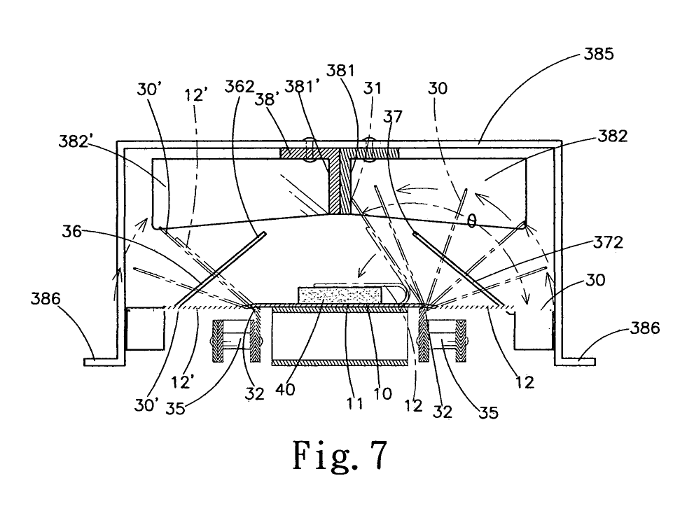

A stuffing transfer unit 50 is disposed above the transfer belt surface 22 for providing stuffings 40 to a surface 11 of the outer material 10 intermittently (referring to FIG. 4). When the right blades 30 and left blades 30′ are turned upwards, the lateral piece-bodies 12, 12′ of the outer material 10 will be folded so as to enclose the stuffing 40 (referring to FIGS. 7, 8, and 9).

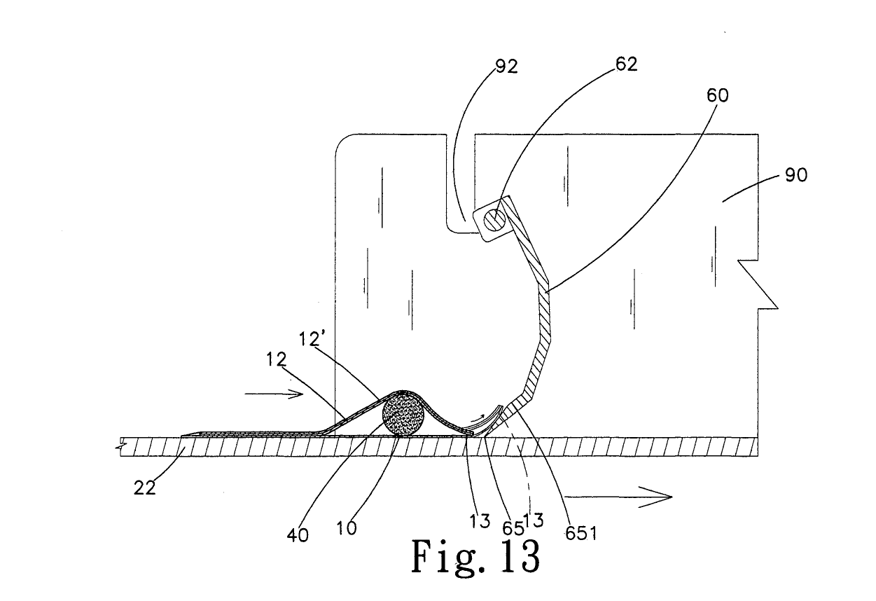

A folding apparatus 60 serves for further folding the outer material 10. A lower end of the folding apparatus 60 has a pick-up end 65. A tip portion 62 of the folding apparatus 60 is movably connected to the upper side of the transfer belt surface 22 and is behind the stuffing transfer unit 50. When the two lateral piece-bodies 12, 12′ enclose the outer material 10 and passes through the folding apparatus 60, the transversal side 13 of the outer material 10 between the two lateral piece-bodies 12, 12′ will be folded by the pick-up end 65 to cover the surfaces of the two left blades 30′ (referring to FIGS. 13, 14 and 15).

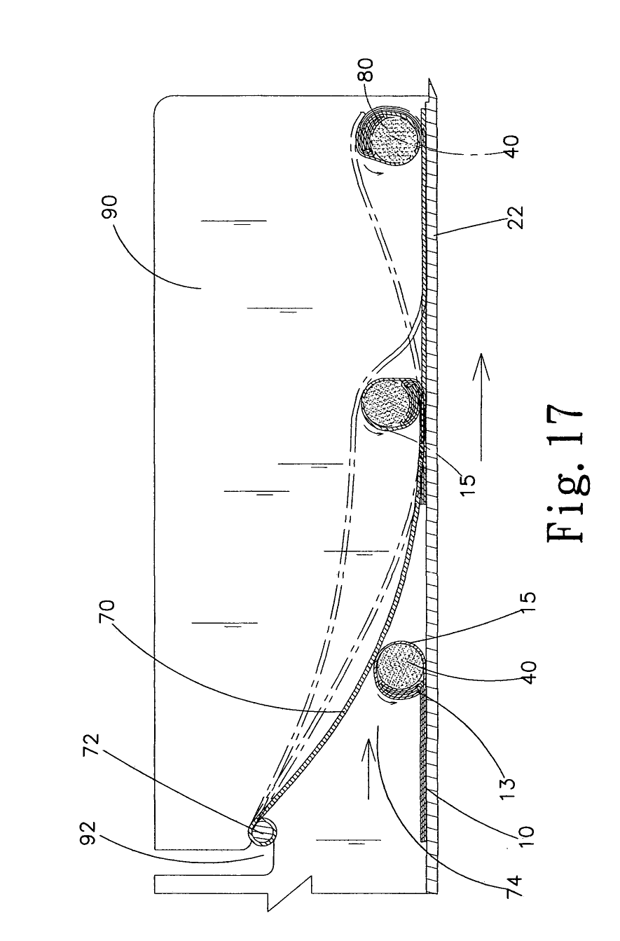

The outer material 10 rolls with the stuffing 40 being used as a rolling axis. The outer material 10 rolls between and contacts a net 70 and a transfer belt surface 22 so as to be rolled as a round strip food (referring to FIG. 17).

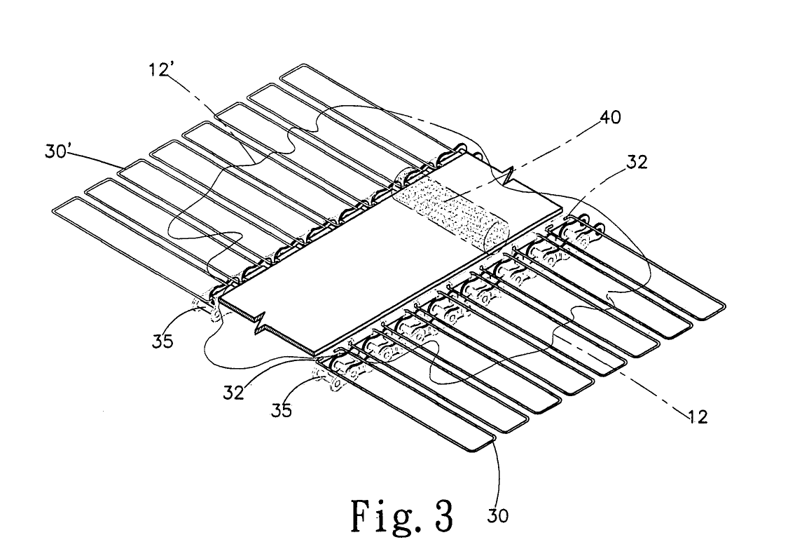

With reference to FIG. 3, in the features of the present invention, the right blades 30 and left blades 30′ are formed by a plurality of strips. The axial portion 32 of each strip is movably connected to chains 35.

There are two chains which are arranged at two sides of the transfer belt surface 22 and can move cyclically. The right blades 30 and left blades 30′ move synchronously with the chains 35.

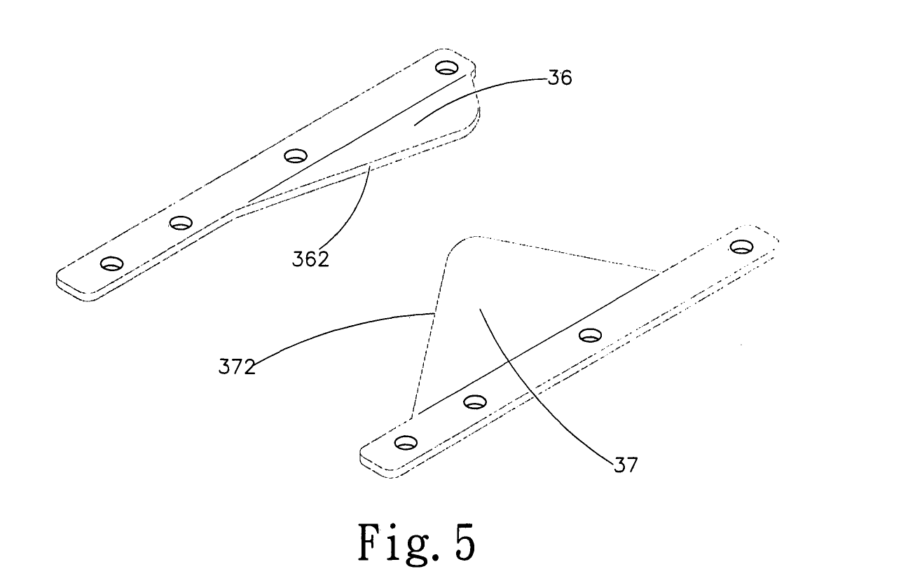

Referring to FIGS. 5 and 7, the left lateral sheet 36 and right lateral sheet 37 are firmly secured to the lateral sides of the chains 35. The lateral sides of the two sheets 36, 37 extend upwards so as to form inclined sliding surfaces 362, 372 for sliding the right blades 30 and left blades 30′.

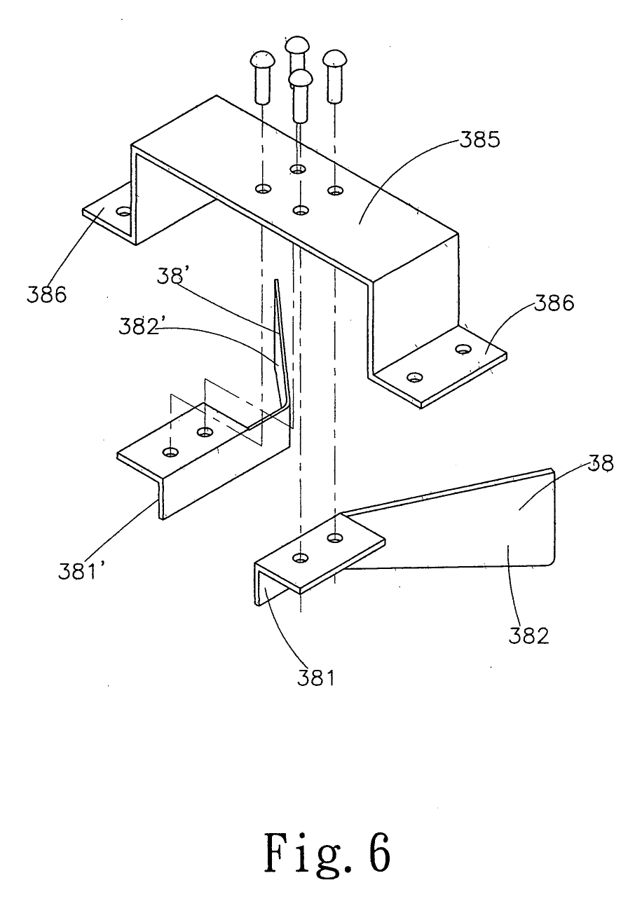

Referring to FIGS. 6, 7, the right upper piece 38 and left upper piece 38′ are disposed above the transfer device 20 by an upper connecting frame 385. The right upper piece 38 is formed by a right angle first sliding surface 381 and a second sliding surface 382 connected to the first sliding surface 381. The left upper piece 38′ is formed by a right angle first sliding surface 381′ and a second sliding surface 382′ connected to the first sliding surface 381′. The moving right blades 30 and left blades 30′ will contact the sliding surfaces 362, 372 of left lateral sheet 36 and the right lateral sheet 37. The right blades 30 and left blades 30′ are guided to turn upwards with a predetermined angle. The effect of the first sliding surfaces 381, 381′ and the second sliding surfaces 382, 382′ serve to guide the upwards-turned right blades 30 and left blades 30′ to return to horizontal position.

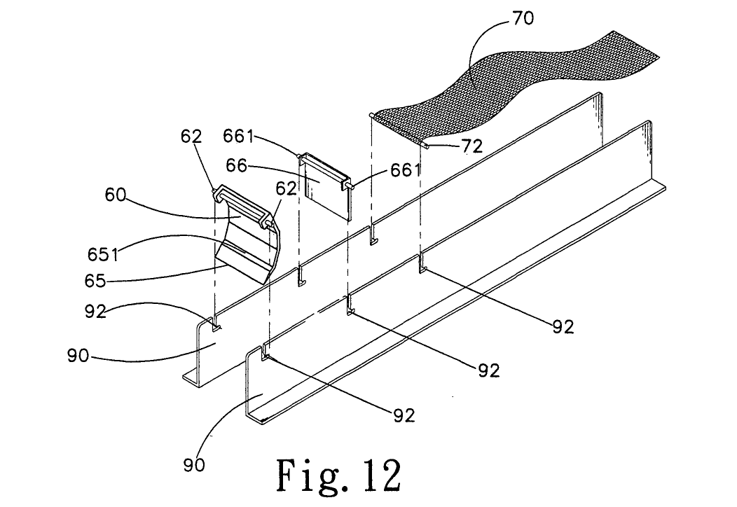

With reference to FIG. 12, the folding apparatus 60 is formed by a cambered sheet. A lower end of the folding apparatus 60 has the pick-up end 65 and an upper end of the folding apparatus 60 has the tip portion 62. The folding apparatus 60 is movably connected to a pivotal hole of two retaining frames 90.

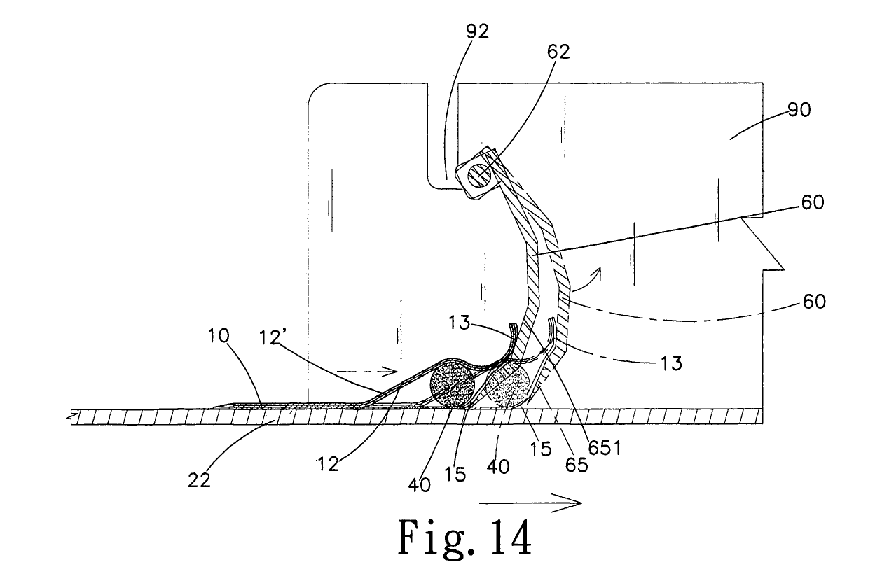

With reference to FIG. 13, when the transversal side 13 of the outer material 10 contacts the pick-up end 65, the transversal side 13 turns upwards along an inner wall 651 of the folding apparatus 60 (referring to FIG. 14). By the rolling force of the stuffing 40 applied upon the folding apparatus 60, the folding apparatus 60 swings outwards along the tip portion 62. The pick-up end 65 moves upwards and outwards for reversely folding the transversal side 13 so that the transversal side 13 covers upper surfaces of the two lateral piece-bodies 12, 12′.

With reference to FIG. 12, a net is installed behind the folding apparatus 60, an outer end of the net 70 has a tip end 72 fixed to the pivotal holes 92 of the two retaining frames 90. Thereby, the net is arranged loosely on the transfer belt surface 22. The folded outer material 10 is transferred forwards and rolls between and in contact with the net 70 and the transfer belt surface 22 so as to form a round strip food (referring to FIG. 17).

Referring to FIGS. 1, 2 and 12, in the round strip food shaping apparatus 100 of the present invention, the two retaining frames 90 are at two lateral sides of the rear portion of the transfer device 20. A plurality of pivotal holes 92 are formed in the two retaining frames 90. The folding apparatus 60, a door, and the net 70 are movably installed to the retaining frames 90 by using pins 62, 661, and 72, respectively.

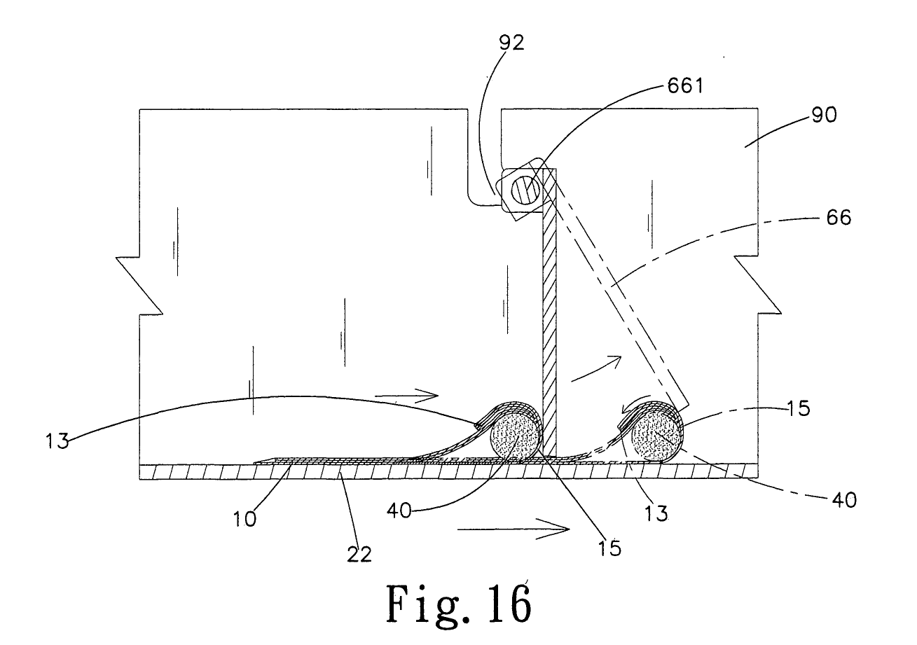

With reference to FIGS. 12, and 16, a door 66 is mounted between the net 70 and the folding apparatus 60. The door 66 is above the transfer belt surface 22.

Moreover, in the present invention, a method for forming round strip foods is provided. The method comprises the steps of moving horizontally a soft and deformable outer material 10 to a predetermined distance and then stopping the outer material 10 (referring to FIG. 1); placing a stuffing 40 upon an upper surface of the outer material 10 (referring to FIG. 4); lifting and turning two lateral piece-bodies 12, 12′ of the outer material 10 at two sides of the moving path of the outer material 10 to cover upon an upper surface of the stuffing 40 (referring to FIGS. 7, 8, and 9); lifting and turning the outer material 10 along the moving path to cover upon the lateral piece-bodies 12, 12′ (referring to FIGS. 13, 14 and 15); rolling the stuffing 40 with the outer material 10 enclosing thereon so that the outer material 10 wound around the stuffing 40 so as to form a round strip food (referring to FIG. 17).

In above structure, the outer material 10 is preferably leaves of shapeable fruits, vegetables, etc.

The operation of the present invention will described herein.

With reference to FIG. 1, the transfer device 20 is installed at a center of the round strip food shaping apparatus 100. The right blades 30 and left blades 30′ are installed at two sides of the transfer device 20. The thin outer material 10 is preferably made from vegetables, or dough. In this example, the outer material 10 is the leaves of grapes even sunk in liquid. The average thickness of the outer material 10 is about 0.5 to 1 m/m. Thereby, the outer material 10 is soft and wet and deformable. The outer material 10 is placed on the transfer device 20 and the right blades 30 and left blades 30′ and is transferred along a predetermined direction. When the outer material 10 is below the stuffing transfer unit 50, the transfer device 20 and right blades 30 and left blades 30′ stops, as shown in FIG. 4. A push rod 52 of the stuffing transfer unit 50 pushes a stuffing 40 out of an outer tube 54. After the short soft stuffing 40 (such as bean paste) will push out horizontally. When an end of the stuffing 40 touches a top post 55 at opposite side will fall to the upper surface 11 of the outer material 10.

Then as shown in FIG. 2, the transfer device 20 and right blades 30 and left blades 30′ move forward continuously. The right blades 30 and left blades 30′ drive by the chains 35 to move cyclically. The movement of the right blades 30 and left blades 30′ are synchronously with the transfer device 20 and the right blades 30 and left blades 30′ are at the same level of the transfer device 20.

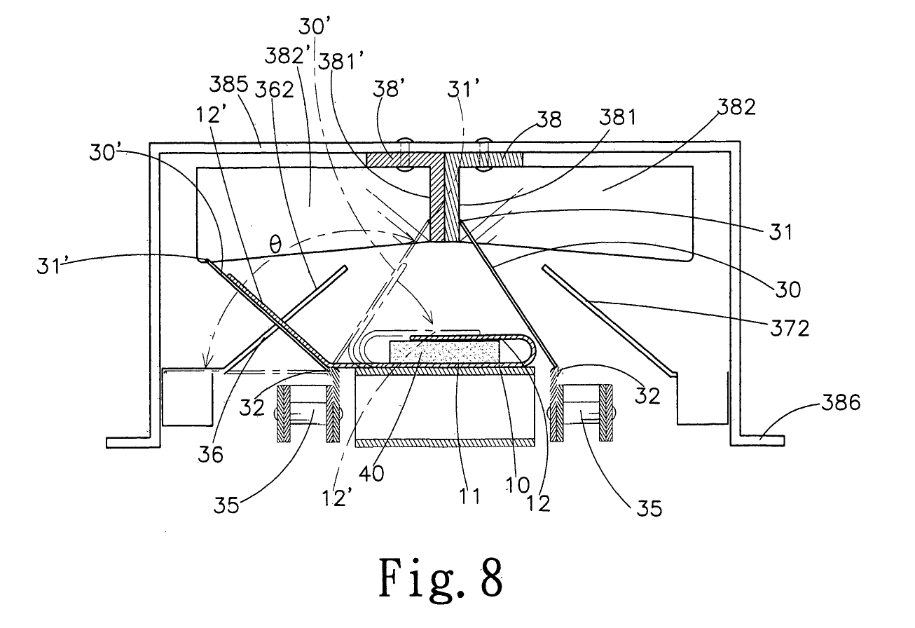

With reference to FIGS. 5 and 7, the left lateral sheet 36 and right lateral sheet 37 are fixed to two lateral sides of the transfer device 20. when the right blades 30 and left blades 30′ moves, the right blade 30 will touch the sliding surface 372 of the right lateral sheet 37, as shown in FIG. 7, so that the right blades 30 moves along the sliding surface 372. When the right blades 30 moves to a predetermined angle, the left blade 30′ at another side initially contacts the sliding surface 362 of the left lateral sheet 36. When the right blade 30 turns with an angle θ larger than 90 degrees, the right lateral piece-bodies 12 is turned and then covers on the surface 11 of the stuffing 40. With reference to FIG. 8, another left lateral piece-body 12′ contacts and slides upon the sliding surface 362 of the left lateral sheet 36. The left lateral piece-body 12′ turns upwards. When the left lateral piece-body 12′ turns with an angle larger than 90 degrees, the left lateral piece-body 12′ is turned and folded by the left blade 30′ and then it covers on the surface 11 of the lateral piece-body 12.

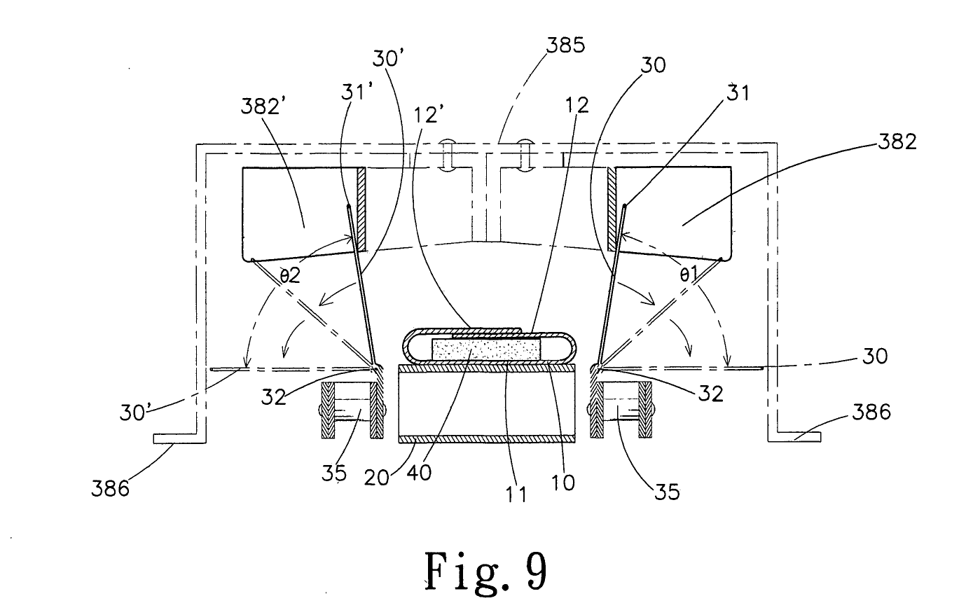

With reference to FIG. 6, the right upper piece 38 and lift upper piece 38′ are fixed and connected to the upper connecting plate 385. Pines 386 at the lateral side of the upper connecting plate 385 is flxd to the two lateral sides of the transfer device 20. The second sliding surface 382 of the right upper piece 38 is alternatively arranged with the second sliding surface 382′ of the lift upper piece 38′, as shown in FIG. 7. When the right blade 30 moves upwards to a maximum angle θ (larger then 90 degrees) and an outer end 31 thereof is attached to the first sliding surface 381 of the right upper piece 38, when the outer end 31 slides from the first sliding surface 381 to the second sliding surface 382, since the second sliding surface 382 of the right upper piece 38 is oblique outwards, when the outer end 31 slides through the second sliding surface 382 of the right upper piece 38, the angle θ1 is smaller than 90 degrees, as shown in FIG. 9. Thereby, the right blade 30 rotates along the axial portion 32 downwards to return to the horizontal position. The operation is performed cyclically. Similarly, the outer end 31′ of the left blade 30′ slides along the first and second sliding surfaces 381, 382 of the left blade 30′. When the angle between the left blade 30′ and the horizontal line θ2 is smaller than 90 degrees. Then left blade 30′ will turn to horizontal so that the chains 35 causes the right blades 30 and left blades 30′ to displace cyclically.

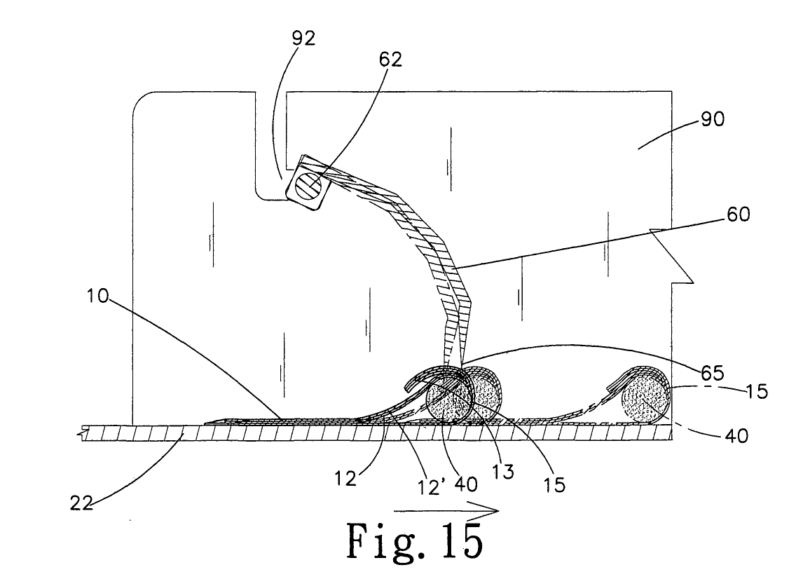

With reference to FIG. 1, the lateral piece-bodies 12, 12′ are folded and the outer material 10 covering the stuffing 40 moves continuously on the transfer belt surface 22. As shown in FIG. 12, the folding apparatus 60 is movably connected to the retaining frames 90 through the pins 62. The pick-up end 65 of the folding apparatus 60 slightly touches the transfer belt surface 22. Since the friction force is smaller, the folding apparatus 60 do not displace. As shown in FIG. 13, when the transversal side 13 of the outer material 10 slides upwards along the inner wall 651, the force of the transfer device 20 is insufficient to push the folding apparatus 60. The folding apparatus 60 does not move. When the outer layer 15 of the stuffing 40 touches the pick-up end 65, the weight of the stuffing 40 is larger so that the rolling force of the stuffing 40 is larger than the resisting force of the folding apparatus 60. Thereby, the folding apparatus 60 rotates along the pin 62, and the pick-up end 65 of the folding apparatus 60 moves backwards and rises, as shown in FIG. 15. In the processing of rising and retracting of the pick-up end 65, the transversal side 13 is turned and wound around the outer layer 15 of the stuffing 40. The rising moving path of the pick-up end 65 serves for moving outwards of the outer layer 15, stuffing 40 and transversal side 13. Next, the transfer device 20 supports the outer material 10 and then they move forwards, as shown in FIG. 16. Since at this moment, the torque of the outer material 10 is larger than the resisting force of the door 66. The door 66 rotates along the pin 661 so that the door 66 is opened to form a path for moving out the outer material 10. The object of the door 66 is that when the outer layer 15 touches the door 66, the outer layer 15 is stuck to the strip-like stuffing 40 so as to prevent the outer layer 15 or the transversal side 13 from loosing before winding.

With reference to FIG. 17, a front end of the soft net 70 is mounted to the retaining frames 90 by pins 72 so that the net 70 looses at the rear section of the transfer belt surface 22 as an inlet 74.

When the transfer belt surface 22 transfers the folded outer material 10 to the inlet 74 at the lower end of the net 70. Then the outer material 10 rolls between the net 70 and the transfer belt surface 22 along the stuffing 40. At this moment, the outer material 10 is wound as a round strip food 80 with the stuffing 40 being in the center portion thereof. The surface of the round strip food 80 contacts the net 70 and the transfer belt surface 22 continuously so that the round strip food rolls along the transfer belt surface 22 so that the round strip food 80 has a concrete structure.

When the round strip food 80 rolls out of the net 70, it is outputted from the transfer belt surface 22.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A round strip food shaping apparatus comprising:
a transfer device having a transfer belt surface which moves forwards along a specific direction;
a plurality of right blades and a plurality of left blades being installed at two lateral sides of the transfer belt surface; a distal end of each right blade and each left blade having a respective axial portion; the right blades and left blades moving forward along a predetermined direction; the movement of the left blades and right blades being identical and synchronous to the transfer belt surface; in the moving process, the right blades and left blades rotating upwards along respective axial portions sequentially from a horizontal direction to a predetermined angle and then rotating downwards sequentially to the horizontal direction;
at least one piece of outer material being used for enclosing a stuffing; if a plurality of outer materials are used, the outer material are equi-distance and horizontally arranged on the transfer belt surface; the at least one outer material has two lateral piece-bodies which are attached to the surface of the right blades and left blades;
a stuffing transfer unit being disposed above the transfer belt surface for providing stuffings to a surface of the outer material intermittently; when the right blades and left blades are turned upwards, the lateral piece-bodies of the outer material will be folded so as to enclose the stuffing;
a folding apparatus for folding the outer material; a lower end of the folding apparatus having a pick-up end; a tip portion of the folding apparatus being movably connected to an upper side of the transfer belt surface and being behind the stuffing transfer unit; when the two lateral piece-bodies enclosing the outer material and passing through the folding apparatus, the transversal side of the outer material between the two lateral piece-bodies will be folded by the pick-up end to cover the surfaces of the two left blades; and the outer material rolling with the stuffing being used as a rolling axis; the outer material rolling between and contacts a net and a transfer belt surface so as to be rolled as a round strip food.

2. The round strip food shaping apparatus as claimed in claim 1, wherein the right blades and left blades are formed by a plurality of strips; the axial portion of each strip is movably connected to chains;
there are two chains which are arranged at two sides of the transfer belt surface and move cyclically; the right blades and left blades move synchronously with the chains;
a left lateral sheet and a right lateral sheet are firmly secured to the lateral sides of the chains; the lateral sides of the two lateral sheets extend upwards so as to form inclined sliding surfaces for sliding the right blades and left blades; and
a right upper piece and a left upper piece are disposed above the transfer device by an upper connecting frame; the right upper piece is formed by a right angle first sliding surface and a second sliding surface connected to the first sliding surface; the left upper piece is formed by a right angle first sliding surface and a second sliding surface connected to the first sliding surface; the moving right blades and left blades will contact the sliding surfaces of left lateral sheet and the right lateral sheet; the right blades and left blades are guided to turn upwards with a predetermined angle; the first sliding surfaces and the second Sliding surfaces serve to guide the upwards-turned right blades and left blades to return to horizontal position.

3. The round strip food shaping apparatus as claimed in claim 1, wherein the folding apparatus is formed by a cambered sheet; a lower end of the folding apparatus has the pick-up end and an upper end of the folding apparatus has the tip portion; the folding apparatus is movably connected to pivotal holes of two retaining frames; and
when the transversal side of the outer material contacts the pick-up end, the transversal side turns upwards along an inner wall of the folding apparatus; by the rolling force of the stuffing applied upon the folding apparatus, the folding apparatus swings outwards along the tip portion; the pick-up end moves upwards and outwards for reversely folding the transversal side so that the transversal side covers upper surfaces of the two lateral piece-bodies.

4. The round strip food shaping apparatus as claimed in claim 1, wherein the net is installed behind the folding apparatus, an outer end of the net has a tip end fixed to the pivotal holes of the two retaining frames; thereby, the net is arranged loosely on the transfer belt surface; the folded outer material is transferred forwards and rolls between and in contact with the net and the transfer belt surface so as to form a round strip food.

5. The round strip food shaping apparatus as claimed in claim 1, wherein in the round strip food shaping apparatus, the two retaining frames are at two lateral sides of the rear portion of the transfer device; the two retaining frames have the plurality of pivotal holes; the folding apparatus, a door, and the net are movably installed to the retaining frames by using pins, respectively.

6. The round strip food shaping apparatus as claimed in claim 1, wherein a door is mounted between the net and the folding apparatus; the door is above the transfer belt surface.

7. A method for forming round strip food comprising the steps of:
moving horizontally a soft and deform able outer material to a predetermined distance;
stopping the movement of the outer material temporary;
placing a stuffing upon an upper surface of the outer material;
lifting and turning two lateral piece-bodies of the outer material at two sides of the moving, path of the outer material to cover upon an upper surface of the stuffing;
lifting and turning a transversal side of the outer material along the moving, path to cover upon the lateral piece-bodies; and
rolling the stuffing with the outer material enclosing thereon sd that the outer material wound around the stuffing to form a round strip food.

5. The method for forming round strip food as claimed in claim 1, wherein the outer material is selected from one of leaves of shapeable fruits, and vegetables.
